(19) United States
(12) Patent Application Publication
(10) Pub. No.: US 2007/0064950 A1
(43) Pub. Date: Mar. 22, 2007

(54) Wireless communication system, wireless communication device, method of wireless communication, and computer program

(76) Inventors: Hideyuki Suzuki, Tokyo (JP); Masaaki Isozu, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/517,388

(22) Filed: Sep. 8, 2006

(30) Foreign Application Priority Data
Sep. 22, 2005 (JP) 2005-274865

(51) Int. Cl. H04K 1/00

(52) U.S. Cl. 380/270

(57) ABSTRACT

A wireless communication system includes plural wireless terminals between which multi-hop communications are performed; wherein processing for extended route search is activated to carry out route search and key exchange at the same time, the processing using a routing control protocol including a key exchange protocol.

### CROSS REFERENCES TO RELATED APPLICATION

The present invention contains subject matter related to Japanese Patent Application JP 2005-274865 filed in the Japanese Patent Office on Sep. 22, 2005, the entire contents of which being incorporated herein by reference.

### BACKGROUND OF THE INVENTION

1. Field of the Invention

The present invention relates to a wireless communication system for communicating between plural wireless stations, to a wireless communication device, to a method of wireless communication, and to a computer program and, more particularly, to a wireless communication system for building a wireless network by ad-hoc communication without installing any specific device acting as a control station and to a wireless communication device, a method of wireless communication, and a computer program used for this purpose.

More specifically, the invention relates to a wireless communication system for providing routing control as a sequence performed when a communication is initiated in an ad-hoc network (also known as a mesh network or multi-hop network) and to a wireless communication device, method of wireless communication, and computer program used for that purpose. Further specifically, the invention relates to wireless communication system, wireless communication device, method of wireless communication, and computer program for stably providing routing control as a sequence performed when a communication is initiated in an ad-hoc network and for permitting secure communications.

2. Description of the Related Art

Wireless networks have attracted attention as communication systems for relieving the user from wired cables for devices relying on a wired system. A wireless network permits a communication terminal to be moved relatively easily through a working space within an office or other similar environment.

When a wireless network is built, it is customary to install a single control station unit known as an “access point” or “point coordinator” within the area, and a network is configured under overall control of the control station. Where an asynchronous communication is performed between a sending communication device and a receiving communication device, it would be necessary in many cases to perform wireless communication via an access point. This will halve the efficiency of utilization of the transmission channel.

In contrast, as another method of building a wireless network, ad-hoc communications have been devised. In particular, terminals are distributed autonomously and interconnected to perform wireless communications without using certain access points. In recent years, electronic devices have been miniaturized and improved in performance and thus can be used easily in mobile environments. Therefore, there is a demand for environments in which terminals can be connected together on ad hoc and on demand basis for performing communications. It is considered that ad-hoc communication is a suitable solution.

In a wireless network, terminal stations that will be communicating parties are not always within reach of their radio waves. Therefore, route search according to a given routing protocol has been performed, and multiple terminals have been interconnected by multi-hop communications.

In an ad-hoc network, the topology varies frequently unlike in related-art fixed networks. Of course, it is important to provide stable routing control. In addition, a mechanism for permitting secure communications is important.

Routing protocols of ad-hoc networks presently proposed are classified into two major categories: on-demand protocol and table-driven protocol. Furthermore, a hybrid protocol combining these two protocols has been proposed.

In a routing scheme using the table-driven protocol or hybrid protocol, route information is typically exchanged between terminals, and the route table is managed to maintain it in the newest state. Examples of such routing include OLSR (Optimized Link State Routing Protocol) and TBRPF (Topology Dissemination Based on Reverse Path Forwarding).

On the other hand, in a routing scheme using the on-demand protocol, a route discovery request is sent immediately before a communication is made, and a route is created. This has been proposed, for example, from the MANET (Mobile Ad Hoc NEtwork Working Group) of the IETF (Internet Engineering Task Force) Typical on-demand protocols include AODV (Ad Hoc On-Demand Distance Vector), DSR (Dynamic Source Routing), and TORA (Temporally Ordered Routing Algorithm) (see, for example, non-patent reference 1).

These methods do not involve a method of realizing secure communications. In other words, to accomplish secure communications, it may be necessary to implement a method different from routing control. That is, secrecy of communications is secured, for example, by creating keys for encrypted communications. That is, it would be necessary to encrypt the communication channels. Furthermore, it may be necessary to set up terminals by a method different from the method of routing control.

IKE (Internet Key Exchange) (see, for example, non-patent reference 2) and Diffie-Hellman key generation protocol (see, for example, non-patent reference 3), for example, are known as key exchange protocols for encrypting communication channels. However, processing for generating encryptic keys using these key exchange protocols is usually performed after a route has been created. Therefore, there is the problem that it takes a long time until the communication is started. Furthermore, control messages for routing control and key exchanges are generated frequently. Consequently, the number of messages processed by each terminal increases. Additionally, the traffic increases, thus resulting in greater load.

[Non-patent reference 1] Charles, E. Perkins et al., “Ad hoc On-demand Distance Vector Routing” (IETF Feb. 17, 2003 pp. 23-25)

<http://www.ietf.org/internet-drafts/draft-ietf-manet-aodv-13.txt>

[Non-patent reference 2] RFC2409

<http://www.ipa.go.jp/security/rfc/RFC2409JA.html>

[Non-patent reference 3] RFC2631

http://www.ipa.go.jp/security/rfc/RFC2631JA.html

### SUMMARY OF THE INVENTION

In view of the foregoing circumstances, it is desirable to provide excellent wireless communication system, wireless communication device, method of wireless communication, and computer program which can stably provide routing control as a sequence performed when a communication is started in an ad-hoc network and which permit the communication to be performed securely.

It is also desirable to provide excellent wireless communication system, wireless communication device, method of wireless communication, and computer program which can perform a secure communication in an ad-hoc network by finishing a sequence in a relatively short time at the beginning of the communication.

Furthermore, it is desirable to provide excellent wireless communication system, wireless communication device, method of wireless communication, and computer program which can finish a sequence performed at the beginning of a communication in an ad-hoc network for route selection and key exchange with a relatively small number of messages processed and with low traffic load.

In view of the foregoing circumstances, the present invention has been made. A first embodiment of the present invention is a wireless communication system which is made up of plural wireless terminals and in which a multi-hop communication is performed between terminals. A key exchange protocol is incorporated in a routing control protocol. Thus, route search and key exchange are performed at the same time.

The “system” referred to herein is a logical assemblage of plural devices or functional modules for realizing certain functions. It does not matter whether the devices or functional modules are incorporated within a single enclosure. This principle is also applied to the following description.

In a wireless network, terminal stations that may communicate with each other are not always within the range of their radio waves. Therefore, routes are discovered according to a given routing protocol, and multiple terminals are interconnected by multi-hop communications. Especially, in the case of an ad-hoc network, the topology varies frequently. Consequently, it is, of course, important to provide stable routing control. In addition, a mechanism enabling secure communications is important.

However, if any of the routing control methods principally used at the time of the filing of the present application is employed to realize secure communications, it may be necessary to encrypt the communication channel by a method different fromthe routingcontrol method. In this case, there is the problem that it takes a long time until a communication is started because processing for generating encryptic keys for the communication channel is performea after a route is found. Furthermore, the number of messages processed between terminals is increased and the traffic load is high.

Accordingly, in one embodiment of the present invention, a communication procedure is introduced which includes carrying out routing control and key exchange at- the same time as a sequence performed at the beginning of a communication between terminals.

Specifically, when a terminal generates a request for transmission of data, a first decision is made as to whether a route has been already established between the sender and the destination terminal. Furthermore, a second decision is made as to whether an encryptic key has been already established. If the results of the decisions are all NOs, processing for extended route search is activated to carry out route search and key exchange at the same time by incorporating a key exchange protocol into the routing control protocol.

In this case, a terminal acting as a sender creates a message for extended route request including a message requesting key exchange within a route request message and sends the message to the destination terminal by broadcast transmission. If an intermediate terminal that is neither the sender nor the destination is involved in the message exchange and if the terminal receives the message, the terminal processes the contents of the message. Then, the terminal routes the message to an appropriate adjacent terminal. Finally, the message is delivered to the destination terminal. The destination terminal creates an extended route reply message including a key reply request message within a route reply message in response to reception of the extended route request message. The destination terminal establishes a reverse route to the sending terminal and sends the message by unicast transmission.

Therefore, according to this embodiment of the present invention, the sequence to be performed at the beginning of a communication can be finished in a relatively short time, and the communication can be conducted securely. Furthermore, the sequence to be performed at the beginning of the communication such as route selection and key exchange can be carried out with a relatively small number of messages processed and with low traffic load.

A second embodiment of the present invention is a computer program described in a computer-readable format such that processing for sending packets in a multi-hop communication environment is performed in a computer system. The program causes the computer system to perform the following steps: deciding in response to generation of a request for transmission of data as to whether a route has been already established between the sender and a destination terminal and as to whether an encryptic key has been already established; performing a route search to the destination terminal of the sent data if results of the step of deciding are that only the route has not been established; exchanging key information with the terminal to which the data is to be sent and creating an encryptic key if the results of the step of deciding are that only the key has not be established; performing an extended route request by creating an extended message for requesting a route including a key exchange request message within a route request message and sending the created message to the destination terminal by broadcast transmission if the results of the step of deciding are that none of the route and encryptic key have been established; performing an extended route reply by creating an extended route reply message including a key reply request message within a route reply message in response to reception of the extended route request message, establishing a reverse route to the sending terminal, and sending the created message by unicast transmission; and sending data packets using the route and encryptic key established in the step of performing a route search, exchanging key information, performing an extended route request or performing an extended route reply.

A computer program associated with a second embodiment of the present invention defines a computer program described in a computer-readable format to realize given processing in a computer system. In other words, the computer program associated with the second embodiment of the invention is installed in the computer system. Thus, the computer system shows a cooperative action and acts as a wireless communication device. Such wireless communication devices are activated and operated as communication terminals to build a wireless ad-hoc network. As a result, the same advantages as the advantages produced by the wireless communication system associated with the first embodiment of the present invention can be obtained.

According to one embodiment of the present invention, excellent wireless communication system, wireless communication device, method of wireless communication, and computer program which can provide routing control stably as a sequence to be performed at the beginning of a communication in an ad-hoc network and which enable secure communications can be offered.

According to another embodiment of the invention, excellent wireless communication system, wireless communication device, method of wireless communication, and computer program which can perform secure communications after finishing a sequence to be performed at the beginning of each communication in an ad-hoc network in a relatively short time can be offered.

According to a further embodiment of the invention, excellent wireless communication system, wireless communication device, method of wireless communication, and computer program which can carry out a sequence with a relatively small number of messages processed and with low traffic load at the beginning of each communication in an ad-hoc network such as route selection and key exchange can be offered.

According to a still other embodiment of the invention, routing control and key exchange are performed at the same time as a sequence at the beginning of a communication between terminals. This shortens the time taken until the communication is started. The number of exchanged messages can be reduced.

Other objects, features, and advantages of the present invention will become apparent from the detailed description of the invention given based on the following embodiments of the invention and accompanying drawings.

### BRIEF DESCRIPTION OF THE DRAWINGS

FIGS. 1A and 1B are diagrams showing an example of configuration of a wireless ad-hoc network to which an embodiment of the present invention can be applied.

FIG. 2 is a diagram showing the internal configuration of a wireless communication device operating in the wireless ad-hoc network shown in FIGS. 1A and 1B.

FIG. 3 is a table showing an example of configuration of a route table 610 held in a memory 600 within a communication processing portion 110 of a wireless communication device 100.

FIG. 4 is a table showing an example of configuration of a key table 620 held in the memory 600 within the communication processing portion 110 of the wireless communication device 100.

FIGS. 5A and 5B are diagrams illustrating a procedure for establishing a route between terminals in a wireless ad-hoc network.

FIGS. 6A and 6B are diagrams illustrating a procedure for establishing a key between terminals in a wireless ad-hoc network.

FIG. 7 is a diagram showing an example of format of an extended route request message.

FIG. 8 is a diagram showing an example of format of an extended route reply message.

FIG. 9 is a flowchart illustrating a procedure processed when data packets are sent by the wireless communication device 100 operating as a terminal within an ad-hoc network.

### DESCRIPTION OF THE PREFERRED EMBODIMENTS

Embodiments of the present invention are hereinafter described in detail with reference to the drawings.

One embodiment of the present invention relates to a wireless ad-hoc network and offers a mechanism of providing stable routing control in preparation for frequent variations of the topology and performing secure communications. Specifically, routing control and key exchange are performed at the same time as a sequence to be performed at the beginning of a communication between terminals. This shortens the time taken until the communication is started. The number of exchanged messages is reduced.

An embodiment of the present invention is accomplished by extending a related-art on-demand routing control such as AODV. The embodiment of the invention can also be applied to routing control methods other than AODV such as DSR and TORA as long as the routing control is of the on-demand type. These methods of routing control are not different essentially. In principle, an embodiment of the present invention can be applied to methods other than the method of on-demand routing control such as table-driven method and hybrid method. The embodiment of the present invention is especially effectively applied to a method of routing control in which processing of messages occurs frequently and the traffic load is high. For convenience of illustration, the following description is based on AODV.

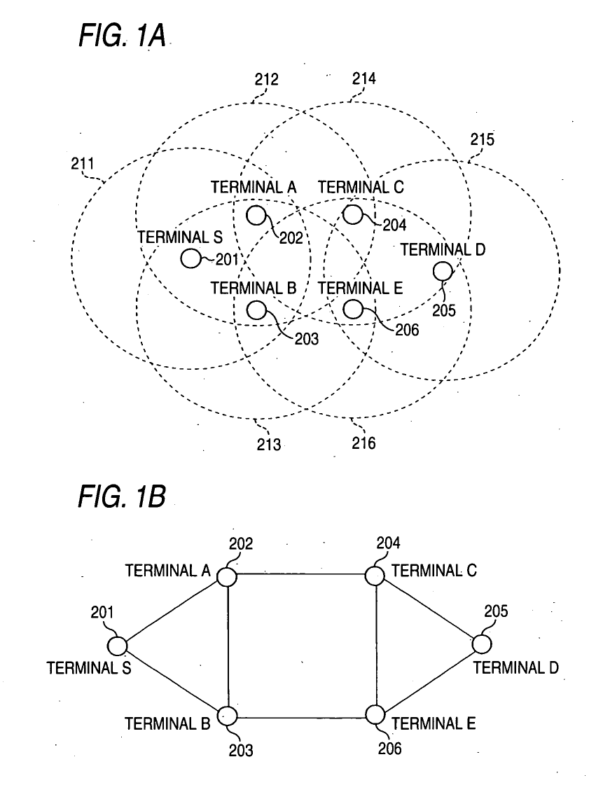

FIGS. 1A and 1B show an example of configuration of a wireless ad-hoc network to which an embodiment of the present invention can be applied. In FIG. 1A, six terminals (from terminal S (201) to terminal E (206)) constitute a network of a wireless ad-hoc communication system. The dotted lines around the terminals indicate the communication ranges 211-216, respectively, of the terminals 201-206, respectively.

For example, the terminals A (202) and B (203) are contained in the communication range 211 of the terminal S (201). The terminals S (201), B (203), and C (204) are contained in the communication range 212 of the terminal A (202). The terminals S (201), A (202), and E (206) are contained in the communication range 213 of the terminal B (203). The terminals A (202), D (205), and E (206) are contained in the communication range 214 of the terminal C (204). Furthermore, the terminals C (204) and E (206) are contained in the communication range 215 of the terminal D (205). In addition, the terminals B (203), C (204), and D (205) are contained in the communication range 216 of the terminal E (206).

The connective relationship between these terminals is schematically shown in FIG. 1B. In this figure, only terminals existing within the mutual communication ranges 211-216 are interconnected by straight lines. The terminals not connected directly are outside the communication ranges. In this way, in a wireless network, terminal stations which will communicate with each other are not always located within the range of their mutual radio waves. Therefore, where a communication is performed between terminals located outside the communication range, multiple terminals are interconnected by a multi-hop communication. Especially, in an ad-hoc network, the topology varies frequently. Consequently, it is important to provide stable routing control as a matter of course. In addition, a mechanism enabling secure communications is important.

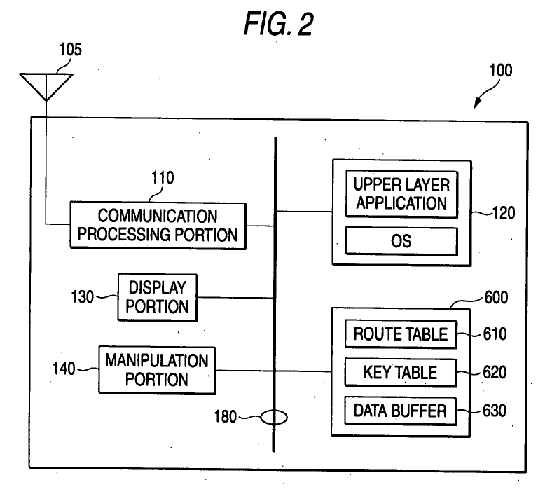

The internal configuration of a wireless communication device operating in the wireless ad-hoc network shown in FIGS. 1A and 1B is shown in FIG. 2. The shown wireless communication device, 100, has a communication processing portion 110, a control portion 120, a display portion 130, a manipulation portion 140, and a memory 600. These are interconnected by a bus 180.

The communication processing portion 110 performs processing of communication protocols below the data link layer. More specifically, an antenna 105 is connected with the communication processing portion 110. A signal received via the antenna 105 is downconverted to form frames at the data link layer. The processing portion also upconverts the frames at the data link layer and sends the upconverted frames from the antenna 105.

The control portion 120 executes an application program under a working environment offered by an operating system and controls the whole of the wireless communication device 100. For example, a communication application is executed on the control portion 120, and processing for communication protocols over the network layer is performed.

In the present embodiment, the control portion 120 performs processing about communication protocols. The processing includes route search, key exchange with each terminal to which packets will be sent, and extended route search. The extended route search is processing for executing route search and key exchange at the same time by incorporating a key exchange protocol into a routing control protocol. This will be described in detail later.

The display portion 130 is a device for displaying given information. For example, a liquid crystal display is used as the display portion. The manipulation portion 140 is a device that is manipulated from the outside to give instructions to the wireless terminal 100. For example, a keyboard and button switches are used as the manipulation portion.

Data necessary for the operation of the control portion 120 is stored in the memory 600. In the present embodiment, a route table 610 for holding information about the route through which a connection is made to the present terminal, a key table 620 for holding an encryptic key exchanged with the destination terminal to which packets will be sent, and a data buffer 630 for holding data to be sent to other terminals are contained in the memory 600.

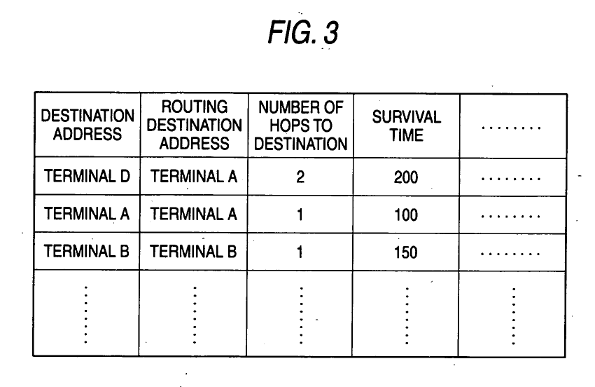

FIG. 3 shows an example of configuration of the route table 610 held in the memory 600 within the communication processing portion 110 of the wireless communication device 100 associated with the present embodiment. A route entry is prepared in the route table 610 for each individual-destination. In the illustrated example, one route entry holds a destination address, a routing destination address, the number of hops to destination, the survival time, and so on. The route table 610 typically has one routing destination address per destination address. Where there is no destination address in the route table 610 (i.e., no route entry is prepared), it follows that any route to the destination does not exist.

The address of the final destination terminal in the route is written in each destination address. Any address can be used as long as the address permits the terminal to be uniquely identified. For example, a MAC (Media Access Control) address or IP (Internet Protocol) address can be used. The routing destination address indicates the address of a terminal to which a next transfer is made for arrival at the corresponding destination address, i.e., the address of the next-hop destination.

The number of hops to destination is the number of links necessary to arrive at the corresponding destination address. For example, in the example shown in FIG. 1B, it maybe necessary to pass through two links in total in order to reach the terminal S from the terminal C by way of the terminal A. In this case, therefore, the number of hops is “2”. The survival time is a parameter indicating a so-to-speak effective period of the corresponding packet. Packets can be prevented from wastefully hopping around in the wireless network by limiting the survival time of the packets; otherwise, the bandwidth would be wasted.

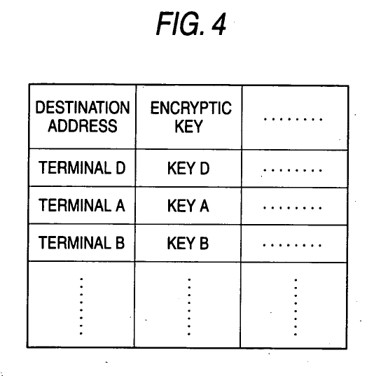

FIG. 4 shows an example of configuration of a key table 620 held in the memory 600 within the communication processing portion 110 of the wireless communication device 100 associated with the present embodiment. In the key table 620, a key entry is prepared for each individual destination to which packets will be sent. In the illustrated example, each one key entry holds an destination address, an encryptic key used when packets are sent to the destination, and other information.

An address permitting a destination terminal to be uniquely identified is written in the destination address. For example, a MAC address or IP address can be used in the same way as in the above description.

An encryptic key is created between terminals by executing processing complying with a given key exchange protocol with a terminal to which packets will be sent before the transmission of the packets. Typical examples of key exchange protocols include IKE and Diffie-Hellman key generation protocols. However, the gist of the present invention is not limited to these protocols.

Where there is no destination address (i.e., no key entry is prepared) in the key table 620, it follows that no key has been established for the destination. When packets are sent, a key is established with the communicating party by a key exchange process and a key entry is registered into the key table 620.

In the illustrated example, there is one key for one destination address. That is, one key entry is created for each individual destination. Of course, plural keys may be established for one destination.

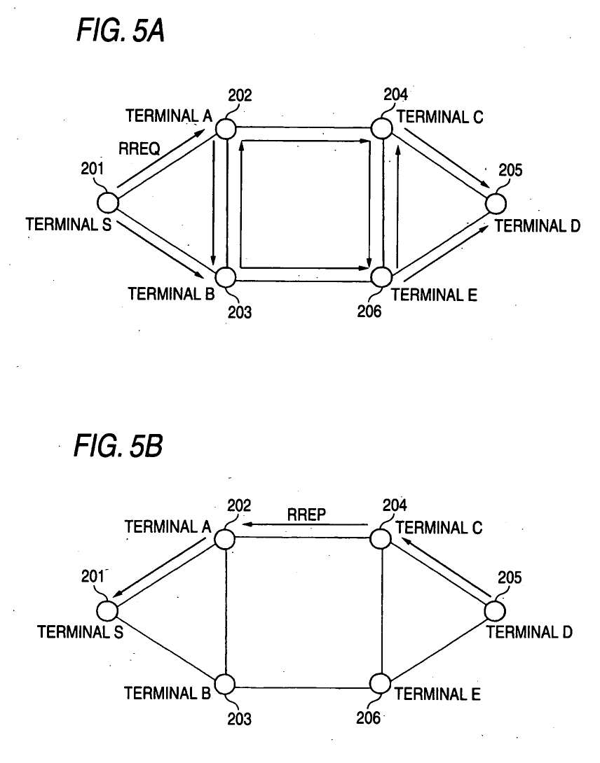

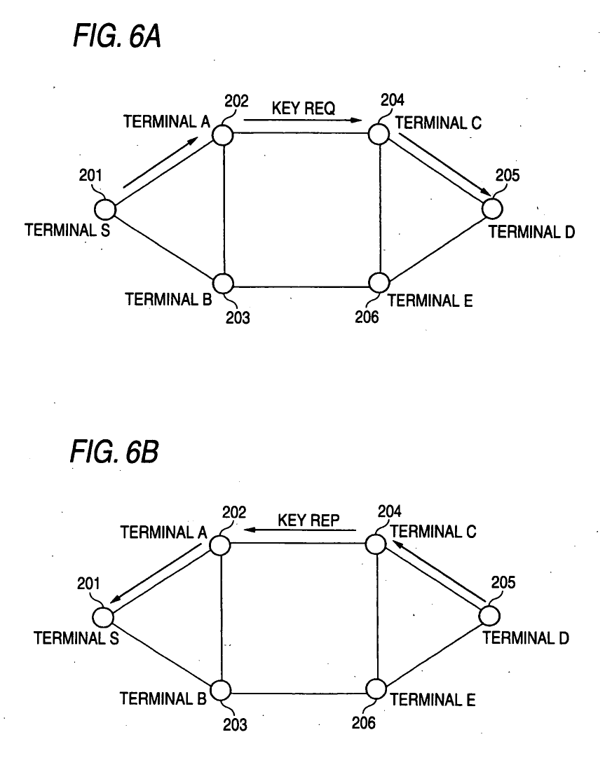

In an ad-hoc network, the topology varies frequently. Therefore, the wireless communication device operating under this network environment may need to provide stable routing control. When packets are sent, it may be necessary for the communication device to establish a key with the communicating party and to perform secure communications. First, route setting process and exchange process are described by referring to FIGS. 5A, 5B, 6A and 6B, respectively.

FIGS. 5A and 5B illustrate a procedure for establishing a route between terminals in the wireless ad-hoc network shown in FIGS. 1A and 1B. Where no route is established between some terminals, a related-art technique can be used as a procedure for establishing a route at first. For example, with AODV protocols, a route request message is sent from an originator terminal to a destination terminal, and a route reply message is sent from the destination terminal to the originator terminal. Thus, a route is established.

The flow of packets occurring when a route request is made to the terminal D (205) from the terminal S (201) is shown in FIG. 5A. When data is sent to the terminal D, if no route to the terminal D has been established (i.e., no route entry for the terminal D is present in the route table), the terminal S enters a route discovery process. First, the terminal S broadcasts a Route REQuest message (RREQ). The terminals A (202) and B (203) receiving the route request message establishes a reverse route or reverse path to the terminal S that is a sender of the route request message. Where there is a request to send data to the sender of route request message, the reverse path or reverse route referred to herein is a route that operates the adjacent terminal that has sent the route request message as a next routing destination.

Since the destination is not the present terminal itself, the terminals A and B receiving the route request message further broadcasts the message. As a result, the route request message is passed to the terminal C (204) and to the terminal E (206). On the other hand, the route request message broadcasted by the terminal A is also received by the terminals S and B. Since the request identifier attached to the route request message is coincident, the message is discarded in the terminals S and B. Similarly, the route request message broadcasted by the terminal B is discarded in the terminals S and A. In this way, the request identifier is used for check for double reception.

The terminals C and E receiving the route request message establishes a reverse route to the terminal S and then broadcasts the route request message further. Thus, the route request message arrives at the terminal D (205). Although the terminal D receives the route request message from both terminals C and E, the terminal D discards the route request message received later.

The flow of packets occurring when a route response is made from the terminal D to the terminal S is shown in FIG. 5B. The terminal D establishes a reverse route (Reverse Path) to the terminal S and then sends a Route REPly message (RREP) to the terminal S that is a sender by unicast transmission. For example, where the terminal D responds to the route request message from the terminal C, the terminal D makes a unicast transmission using the terminal C as a next destination. Where there is a request for transmission of data to the sender of an extended route request message, for example, the reverse route is a path that makes the adjacent terminal, which has sent the message, a next-hop destination.

The terminal C receiving the route reply message establishes a reverse route to the terminal D that is a sender of the route reply message. The terminal C then routes the route reply message to the terminal A. Similarly, the terminal A receiving the route reply message establishes a reverse route to the terminal D that is the sender of the route reply message and routes the message to the terminal S.

The terminal S receiving the route reply message establishes a reverse route to the terminal D that is the sender of the route reply message. The terminal S writes the contents of the settings of the route into the route entry corresponding to the destination terminal D and registers the contents into the route table 610. Thus, the route discovery process is completed.

Where an on-demand routing control protocol is applied, a route setting procedure is activated before the first data packet is sent to a destination. That is, when a data packet is attempted to be sent to a destination not contained in the route table, a route is created. Usually, once a route is created, it is retained for a given period.

FIGS. 6A and 6B illustrate a procedure for establishing a key between terminals in the wireless ad-hoc network shown in FIGS. 1A and 1B. When packets are sent, if no key is established with the destination terminal, it would be necessary to create an encryptic key common to these two terminals. In the illustrated example, it is assumed that the terminal S (201) makes a request for a key to the terminal D (205). For simplicity of explanation, a previously established route is used.

The flow of packets occurring when the terminal S (201) makes a request for a key to the terminal D (205) is shown in FIG. 6A. In the illustrated example, the terminal S (201) sends a Key REQuest message (KeyREQ) to the terminal A (202) that is a routing designation written in the route table. The terminal A receiving the key request message routes it to the terminal C (204) that is a routing destination written in the route table. The terminal D (205) that is the destination can receive the key request message via the terminal C (204).

The flow of packets occurring when a key-reply message is sent from the terminal D to the terminal S is shown in FIG. 6B. Since the reverse route from the terminal D to the terminal S has been established in the route table, a Key REPly message (KeyREP) is sent to the terminal S that is the sender by unicast transmission. In this case, the terminal D sends the key-reply message to the terminal C that is a routing destination written in the route table. The terminal C routes the message to the terminal A that is a route destination written in the route table. The terminal S that is a responding terminal can receive the key-reply message via the terminal A.

The exchange of messages of key request and key reply are carried out once or repeated a given number of times to thereby create the encryptic key common to the terminals S and D. Key exchange can be done securely. In each of the terminals S and D, a destination and a created encryptic key are written in key entries and registered in the key table 620. Thus, the key exchange process ends.

Any related-art route setting process does not contain a method of realizing secure communications and, therefore, in order to secure communication privacy, it may be necessary to perform key exchange for encrypted communications by a process different from the routing control. In this case, there is the problem that it takes a long time until a communication is started because encryptic key generation for the communication channel relying on the key exchange protocol is performed after the route has been created. Furthermore, the number of messages processed is increased. In addition, the traffic load is high.

Accordingly, in the present embodiment, the sequence to be performed at the beginning of a communication between terminals is finished in a short time by introducing a communication procedure including performing routing control and key exchange at the same time. Secure communication routes can be secured with a reduced number of messages processed and with lower traffic load.

As a specific mounting method, a key exchange request message and a key exchange reply message are included in a route request message and a route reply message. Thus, the number of exchanged messages is reduced. Messages obtained by including information for a key exchange protocol in the route request message and route reply message in this way are referred to as extended route request message (Extended Routing Request) and extended route reply message (Extended Routing Reply), respectively. Route setting and key exchange process involving a reduced number of exchanged messages are accomplished by exchanging the extended route request message and the extended route reply message between a sending node and a destination node.

The terminal that becomes a sender of packets creates an extended route request message and sends it to a destination terminal by broadcast transmission. This extended route request message is delivered to the destination terminal according to a route setting process, for example, as shown in FIG. 5A. Meanwhile, if the destination terminal receiving the extended route request message creates an extended route reply message, the terminal establishes a reverse route to the sending terminal and sends the message by unicast transmission.

If an intermediate terminal that is neither the sender nor the destination and is involved in message exchange receives the above-described messages, then the terminal processes the contents of the messages and then routes the resulting data to an appropriate adjacent terminal.

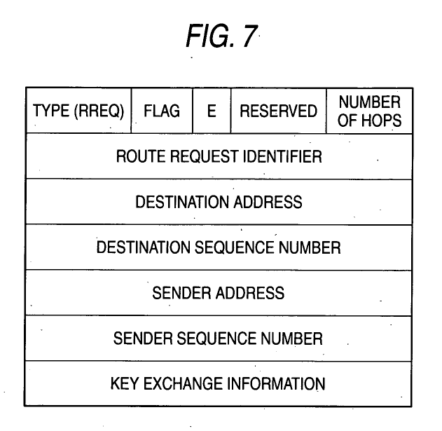

An example of format of extended route request messages is shown in FIG. 7. Each extended route request message includes a bit field E indicating that the route request message is of the extended type. The message further contains information for key exchange. It is assumed here that a Diffie-Hellman key exchange method is used as a key exchange protocol. The sender creates a private key “PrivKey_S”, calculates a public key PubKey_S=α^{PrivKey}^{_{—}}^{s} mod q (where α is the primitive root of the prime number q), and includes it into an extended route request message.

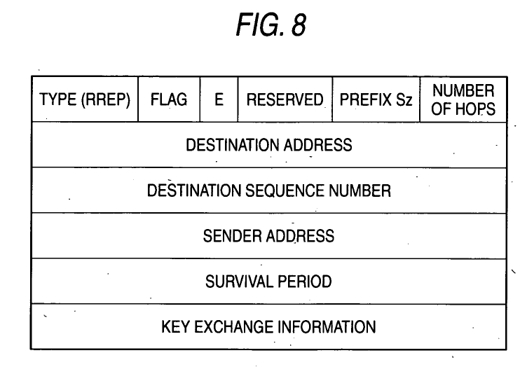

An example of format of extended route reply messages is shown in FIG. 8. Each extended route reply message has a bit field E indicating that the route reply message is of the extended type. The message contains information for key exchange. At this point, the receiving terminal creates an encryptic key by calculating K=(PubKey_S)^{PrivKey}^{_{—}}^{D} mod q.

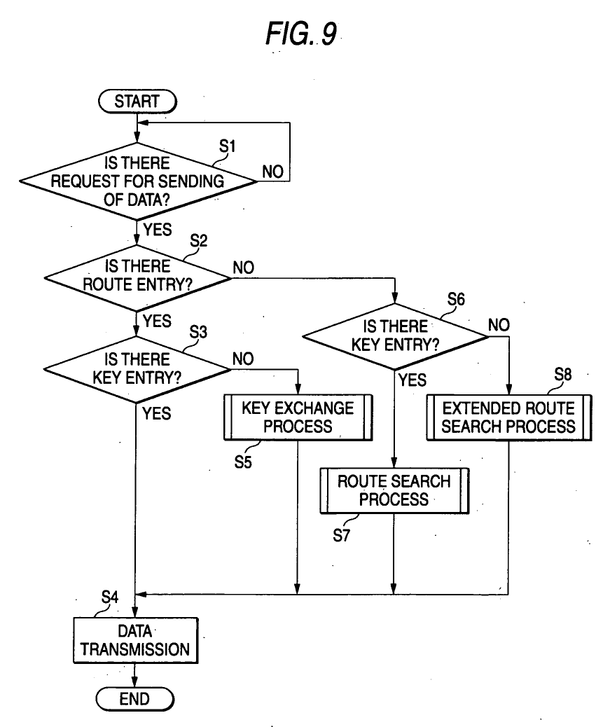

FIG. 9 is a flowchart illustrating a processing procedure used when data packets are sent by the wireless communication device 100 operating as a terminal within an ad-hoc network.

If there is a request for sending of data packets from a higher layer application (step S1), a decision is made as to whether an entry of a route for the destination terminal already exists within the route table 610 (step S2).

If such entry of a route for the destination terminal already exists, a decision is made as to whether a key entry about the destination is already present in the key table 620 (step S3).

If such a key entry for the destination is present in the key table 620, the data packets required to be sent are encrypted using the encryptic key written in the entry and transmitted (step S4).

If there is a route entry for the destination (i.e., a route has been already established) but there is no key entry for the destination (step S3), it may be necessary to create an encryptic key with the destination terminal. Therefore, the processing for key exchange is activated. The destination and created encryptic key are written into the key entry and registered into the key table 620 (step S5). It is assumed here that a Diffie-Hellman key exchange method is used. The data packets required to be sent are encrypted using the created encryptic key and transmitted (step S4).

If the result of the decision of step S2 is that the route table 610 contains no route entry about the destination terminal, a decision is then made as to whether a key entry about the destination is already present in the key table 620 (step S6).

If a key entry about the destination exists (i.e., a key has been already established) but there is no route entry about the destination, the processing for a route search is activated and a route is established (step S7). It is now assumed that route setting processing according to an AODV protocol is performed. When the route setting ends, the contents of the setting about the route are written into the route entry corresponding to the destination terminal D and registered into the route table 610. Data packets required to be sent are encrypted and transmitted to the next routing destination written in the route entry (step S4).

If the result of step S6 is that neither a route to the destination nor a key with the destination has been established, processing for extended route search is activated. Routing control and key exchange are performed at the same time as a sequence to be performed at the beginning of a communication with the destination terminal (step S8). If this processing ends, a route to the destination is established and a route entry is registered into the route table. An encryptic key shared with the destination is created and a key entry is registered into the key table. Data packets required to be sent are encrypted and transmitted to the next routing destination written in the route entry (step S4).

Processing for extended route search that is performed when none of route and key have been established is described next.

(1) First, a terminal acting as a sender of data packets broadcasts an extended route request message. The format of the extended route request message is as shown in FIG. 7. It is now assumed that a Diffie-Hellman key exchange method is used as a key exchange protocol. The sender creates a private key “PrivKey_S”, calculates a public key PubKey_S=α^{PrivKey}^{_{—}}^{S} mod q (where α is the primitive root of the prime number q), and includes it into the extended route request message.

(2) The adjacent terminal receiving the extended route request message establishes a reverse route (Reverse Path) to the sender while checking for double reception. The terminal further broadcasts the message. As a result of repetition of the broadcasting of such messages, the extended route request message arrives at the destination terminal. If there is a request for sending of data to the sender of the extended route request message, for example, the reverse route makes the adjacent terminal sending the message a next-hop destination.

(3) When receiving the extended route request message, the destination terminal creates a private key “PrivKey_D”, calculates a public key PubKey_D=α^{PrivKey}^{_{—}}^{D} mod q, includes the calculated key into an extended route reply message, and sends the message to the sender by unicast transmission. The format of the extended route reply message is as shown in FIG. 8. At this instant, the receiving terminal creates an encryptic key by calculating K=(PubKey_S)^{PrivKey}^{_{—}}^{D} mod q. The created encryptic key is written into a key entry together with the destination address and registered into the key table 620.

(4) The adjacent terminal receiving the extended route reply message establishes a reverse route to the sender of this message. The extended route reply message is routed along successive terminals in the reverse route established when the extended route search message was broadcasted. As a result, the extended route reply message arrives at the sending terminal.

(5) When the sending terminal of the extended route request message receives the extended route reply message, the terminal extracts the public key of the destination terminal from the message. An encryptic key is created by calculating K=(PubKey_D)^{PrivKey}^{_{—}}^{S} mod q. The processing for extended route search is completed.

When the processing for extended route search is implemented in this way, an encryptic key is created at the same time as the route to the destination.

While the present invention has been described in detail by referring to certain embodiments, it is obvious that those skilled in the art can modify the embodiments or make substitutions without departing from the gist of the present invention.

The embodiments of the present invention can be applied also to DSR (Dynamic Source Routing) protocol and TORA (Temporally-Ordered Routing Algorithm) as well as to AODV (Ad Hoc On-Demand Distance Vector) protocols as long as the protocol provides on-demand routing control. However, these routing control methods are not different essentially. In principle, the embodiments of the present invention can be applied to methods other than the on-demand method such as table-driven protocol and hybrid protocol. The embodiments of the invention is especially advantageously employed in a routing control method which produces processing of message frequently and results in high traffic.

In summary, only exemplary examples of the present invention have been disclosed. The contents of the description of the present specification should not be construed restrictively. To judge the gist of the present invention, reference should be made to the accompanying claims.

It should be understood by those skilled in the art that various modifications, combinations, sub-combinations and alterations may occur depending on design requirements and other factors insofar as they are within the scope of the appended claims or the equivalents thereof.

What is claimed is:

1. A wireless communication system comprising:
plural wireless terminals between which multi-hop communications are performed;
wherein processing for extended route search is activated to carry out route search and key exchange at the same time, the processing using a routing control protocol including a key exchange protocol.

2. The wireless communication system of claim 1, wherein when a request for sending of data occurs in any one of the terminals, a decision is made as to whether a route has been already established between this terminal acting as a sender and a destination terminal and a decision is made as to whether an encryptic key has been already established, and wherein if none have been established, the processing for extended route search is activated.

3. The wireless communication system of claim 1, wherein in the processing for extended route search, a terminal acting as a sender creates an extended route request message having a route request message including a key exchange request message and sends the created message to a terminal acting as a destination by broadcast transmission such that the message is delivered to the destination terminal in accordance with a given route setting process, and wherein the destination terminal creates an extended route reply message having a route reply message including a key reply request message in response to reception of the extended route request message, establishes a reverse route to the sending terminal, and sends the created extended route reply message by unicast transmission.

4. A wireless communication device for sending packets under a multi-hop communication environment, the wireless communication device comprising:
communication means for sending and receiving a wireless signal;
route-setting means for establishing a route with a terminal with which packets are exchanged;
key exchange means for exchanging key information with said terminal and for creating an encryptic key;
extended route setting means for performing route search and key exchange at the same time by activating processing for extended route search, the processing using a routing control protocol including a key exchange protocol; and
data sending processing means for sending data packets by the communication means using the established route and encryptic key.

5. The wireless communication device of claim 4, wherein the extended route setting means activates the processing for extended route search when a request for sending of data occurs and when none of path and encryptic key have been established with a terminal that is a destination.

6. The wireless communication device of claim 4, wherein when the extended route setting means operates as a sender of data, the extended route setting means creates an extended route request message having a route request message including a key exchange request message and sends the created message to a destination terminal by broadcast transmission, and wherein when the extended route setting means operates as a destination of data to be sent, the extended route setting means creates an extended route reply message having a route reply message including a key reply request message in response to reception of the extended route request message, establishes a reverse route to a terminal acting as a sender, and sends the message by unicast transmission.

7. A method of wireless communication adapted to send packets under a multi-hop communication environment, the method comprising the steps of:
deciding as to whether a route has been established between a sender of a request for sending of data and a destination terminal and a decision as to whether an encryptic key has been established in response to generation of the request;
performing a route search up to a terminal acting as the destination of data to be sent if results of the step of deciding are that only a route has not been established;
exchanging key information with the destination terminal to which data is sent and creating an encryptic key if the results of the step of deciding are that only a key has not been established;
performing an extended route search by incorporating a key exchange protocol into a routing control protocol and performing route search and key exchange at the same time if the results of the step of deciding are that none of route and encryptic key have been established; and
sending data packets using the route and the encryptic key established in the step of performing a route search, exchanging key information, or performing an extended route search.

8. The method of wireless communication of claim 7, wherein in the step of performing the extended route search, an extended route request message having a route request message including a key exchange request message is created and broadcast to a terminal acting as the destination.

9. The method of wireless communication of claim 7, further comprising the step of:
creating an extended route reply message having a route reply message including a key reply request message in response to reception of an extended route request message, establishing a reverse route to a terminal acting as a sender, and sending the created message to the terminal by unicast transmission.

10. A computer program described in a computer-readable format such that processing for sending packets under a multi-hop communication environment is performed in a computer system, the computer program being adapted to cause the computer system to perform the steps of:
deciding as to whether a route has been already established between a sender of a request for sending of data and a destination terminal and a decision as to whether an encryptic key has been already established in response to generation of the request for sending of data;
performing a route search up to a terminal acting as a destination of data to be sent if results of the step of deciding are that only a route has not been established;
exchanging information with the destination terminal of data to be sent and creating an encryptic key if the results of the step of deciding are that only a key has not been established;
performing an extended route request by incorporating a key exchange request message into a route request message to create an extended route request message and sending the extended route request message to the destination terminal by broadcast transmission if the results of the step of deciding are that none of route and encryptic key have been established;
performing an extended route reply by incorporating a key reply request message into a route reply message to create an extended route reply message, establishing a reverse route to a terminal of a sender of an extended route request message, and sending the created extended route reply message by unicast transmission in response to reception of the extended route request message; and
sending data packets using the route and the encryptic key established in the step of performing a route search, exchanging key information, performing an extended route request or performing an extended route reply.

11. A wireless communication device adapted to send packets under a multi-hop communication environment, the wireless communication device comprising:
a communication unit operable to send and receive a wireless signal;
a route setting unit operable to establish a route with a terminal with which packets are exchanged;
a key exchange unit operable to exchange key information with said terminal and to create an encryptic key;
an extended route setting unit operable to perform route search and key exchange at the same time by activating processing for extended route search, the processing using a routing control protocol including a key exchange protocol; and
a data sending processing unit operable to send data packets via the communication unit using the established route and encryptic key.
